(19) United States
(12) Patent Application Publication
(10) Pub. No.: US 2009/0019347 A1
(43) Pub. Date: Jan. 15, 2009

(54) DOCUMENT PROCESSING SYSTEM, DOCUMENT INPUT-OUPUT DEVICE, RECORDING MEDIUM STORING DOCUMENT INPUT-OUTPUT PROGRAM, AND DOCUMENT PROCESSING METHOD

(75) Inventors: Takeshi NOGUCHI, Kanagawa (JP); Junichi MATSUNOSHITA, Kanagawa (JP); Kenji EBITANI, Kanagawa (JP); Hirofumi KOMATSUBARA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/119,820

(22) Filed: May 13, 2008

(30) Foreign Application Priority Data
Jul. 13, 2007 (JP) 2007-184411

(51) Int. Cl. G06F 17/00

(52) U.S. Cl. 715/200

(57) ABSTRACT

A document processing system, which includes a document management device having: a management section that manages document information including association between a document and identification information; and an accumulation section that accumulates an electronic document corresponding to the document, and a document input-output device having: a generation section that generates the electronic document; an extraction section that extracts the identification information; a determination section that obtains the document information and determines whether pages are overlapped; a detection section that detects whether an added portion exists in each of the overlapped pages; a deletion section that deletes a page not having the added portion; a controller that controls to incorporate the page having the added portion to a corresponding page in the electronic document; and an output section that outputs the electronic document including the incorporated page, or outputs the electronic document through image formation on a medium.

### CROSS-REFERENCE TO RELATED APPLICATION

This application is based on and claims priority under 35 USC 119 from Japanese Patent Application No. 2007-184411 filed on Jul. 13, 2007.

### BACKGROUND

1. Technical Field

The present invention relates to a document processing system, a document input-output device, a recording medium storing a document input-output program and a document processing method.

2. Related Art

The widespread use of copying machines has made it possible to copy documents with ease.

### SUMMARY

An aspect of the present invention provides a document processing system, which includes a document management device having: a management section that manages document information including association between a document in which identification information is attached to each page and the identification information; and an accumulation section that accumulates an electronic document corresponding to the document, and a document input-output device having: a generation section that generates the electronic document through reading the document; an extraction section that extracts the identification information from the electronic document generated by the generation section; a determination section that obtains the document information managed by the management section based on the identification information extracted by the extraction section and determines whether pages are overlapped in the electronic document generated by the generation section based on the obtained document information; a detection section that detects from the overlapped pages a presence or absence of an added portion in the overlapped pages when the determination section determines the presence of the overlapped pages; a deletion section that deletes a page not having the added portion among the overlapped pages; a controller that controls to incorporate the page having the added portion among the overlapped pages to a corresponding page in the electronic document accumulated in the document management device; and an output section that outputs the electronic document including the incorporated page, or outputs the electronic document as a document through image formation on a medium.

### BRIEF DESCRIPTION OF THE DRAWINGS

Exemplary embodiments of the present invention will be described in detail based on the following figures, wherein:

FIG. 1 is a diagram illustrating an example configuration of a document management system;

FIG. 2 is a block diagram illustrating a configuration of a document management device 2 and a document input-output device 3;

FIG. 3 is a block diagram illustrating a functional configuration of the document management device 2 and the document input-output device 3;

FIGS. 4A and 4B are diagrams illustrating an example of information managed in a document information management section;

FIG. 5 is a diagram illustrating an example document to which a code is added;

FIG. 6 is a flowchart illustrating an operational flow of the document input-output device 3;

FIG. 7 is a flowchart illustrating an operational flow of the document input-output device 3;

FIG. 8 is a flowchart illustrating an operational flow of the document input-output device 3;

FIG. 9 is a flowchart illustrating a flow of a document correction processing in Second Example;

FIG. 10 is a block diagram illustrating a functional configuration of a document input-output device 7 in Third Example.

### DETAILED DESCRIPTION

With reference to accompanying drawings, description will be made in detail below of exemplary embodiments of a document processing system, a document input-output device, a recording medium storing a document input-output program and a document processing method according to the present invention.

### First Example

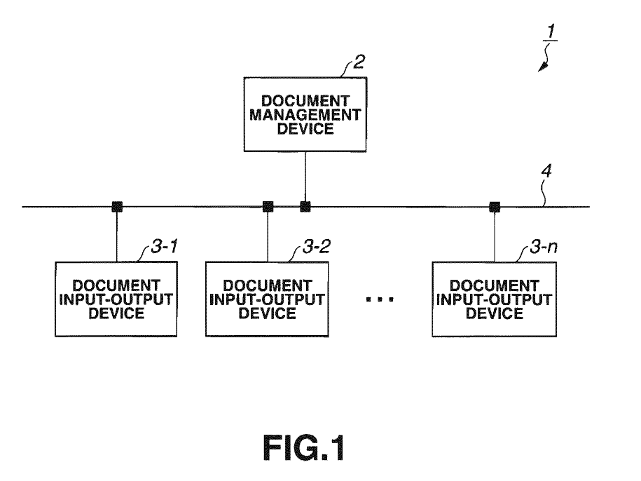

FIG. 1 is a diagram illustrating an example configuration of a document management system. As shown in FIG. 1, the document management system is formed by connecting a document management device 2 and document input-output devices 3 (3-1 to 3-n) via a network 4.

The document management device 2 stores documents in a form of electronic documents such as image files, files formed in a page description language, and manages relationships between documents and pages forming each of the documents and so on.

The document input-output device 3 optically reads a document, outputs the read document as an electronic document or prints out the read document. If there exists excess or insufficiency of the pages in the read document, the document input-output device 3 implements processing of issuing a caution and so on.

Next, the document management device 2 and the document input-output device 3 will be explained in detail. The document management device 2 is realized, for example, by executing a program that manages the documents in a general-purpose information processing device such as a computer. The document input-output device 3 is realized, for example, by executing a program for inputting or outputting documents in an image formation device having image reading device, such as a copying machine.

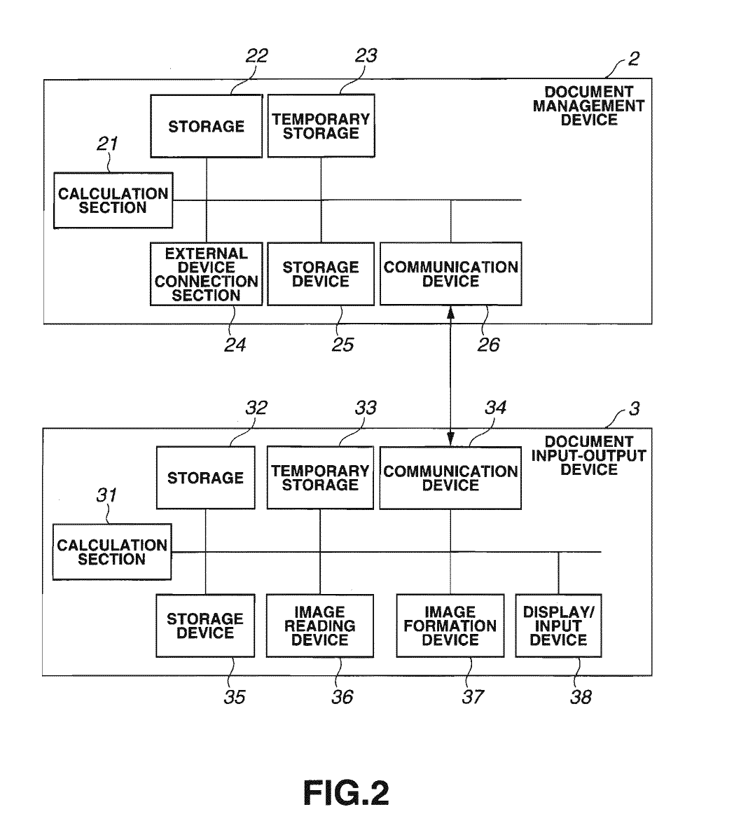

FIG. 2 is a block diagram illustrating a configuration of the document management device 2 and the document input-output device 3. As shown in FIG. 2, the document management device 2 includes a calculation section 21, a storage 22, a temporary storage 23, an external device connection section 24, a storage device 25 and a communication device 26.

The calculation section 21 is a section that performs calculation processing, and is, for example, a processor such as a CPU (Central Processing Unit). The storage 22 is a section that stores a program for operating the document management device 2, and so on, and is, for example, a ROM (Read Only Memory), an EEPROM (Electronically Erasable and Programmable Read Only Memory) and so on. The temporary storage 23 is a section that temporarily stores information at the time when the calculation section 21 operates, and is, for example, a RAM (Random Access Memory). The external device connection section 24 is an interface for connecting to such displaying device as a monitor or such input device as a keyboard. The storage device 25 is a storage that stores a program for operating the document management device 2, an electronic document, management information on the electronic document and so on, and is, for example, a hard disc, etc. The communication device 26 is an interface for performing a communication via the network 4.

Additionally, the document input-output device 3 includes a calculation section 31, a storage 32, a temporary storage 33, a communication device 34, a storage device 35, an image reading device 36, an image formation device 37 and a display/input device 38.

The calculation section 31 is a section that performs calculation processing, and is, for example, a processor such as a CPU. The storage 32 is a section that stores a program for operating the document input-output device 3 or other data, and is, for example, a ROM, an EEPROM and so on. The temporary storage 33 is a section that temporarily stores information at the time when the calculation section 31 operates, and is, for example, a RAM. The communication device 34 is an interface for performing a communication via the network 4. The storage device 35 is a storage that stores an electronic document obtained through optically reading the original document or other data, and is, for example, a hard disc, etc. The image reading device 36 is a device that optically reads the original documents and generates the electronic document and so on. The image formation device 37 is a device that forms an image on a paper sheet or other medium. The display/input device 38 is a device that displays information for an operator who operates the document input-output device 3 and receives an instruction.

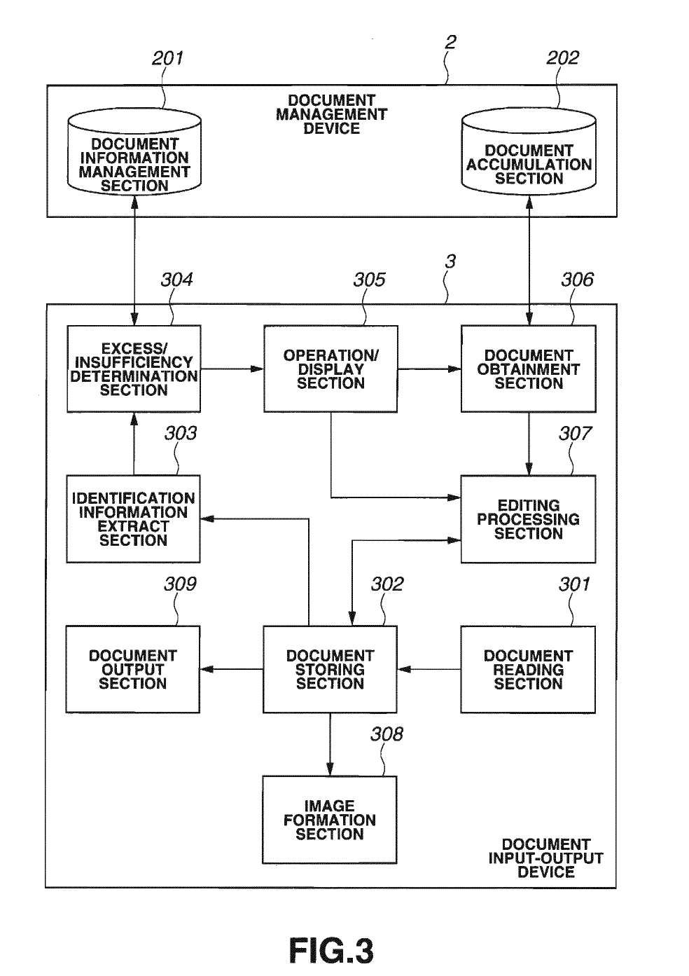

FIG. 3 is a block diagram illustrating a functional configuration of the document management device 2 and the document input-output device 3. As shown in FIG. 3, the document management device 2 includes a document information management section 201 and a document accumulation section 202.

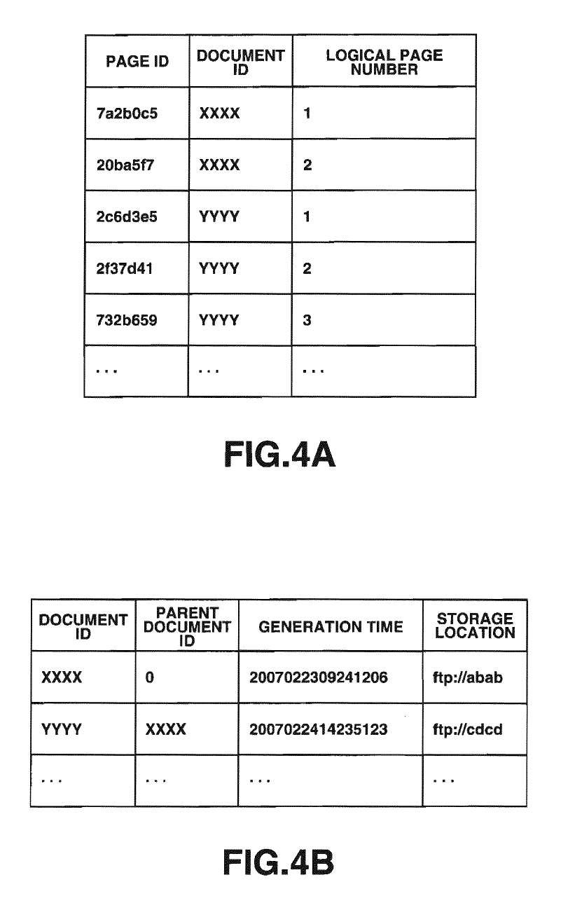

The document accumulation section 202 accumulates an electronic document in a manner that can print out the electronic document on a per-page basis. The document information management section 201 manages information on the document accumulated in the document accumulation section 202. For example, as shown in FIG. 4A, a page ID attached to each page in the electronic document is managed in association with a document ID of the document including the page and a logical page number of the page in the document. Additionally, as shown in FIG. 4B, the document ID indicating the document is managed in association with a parent document ID of a parent document that is a parent of the document, a generation time and a storage location.

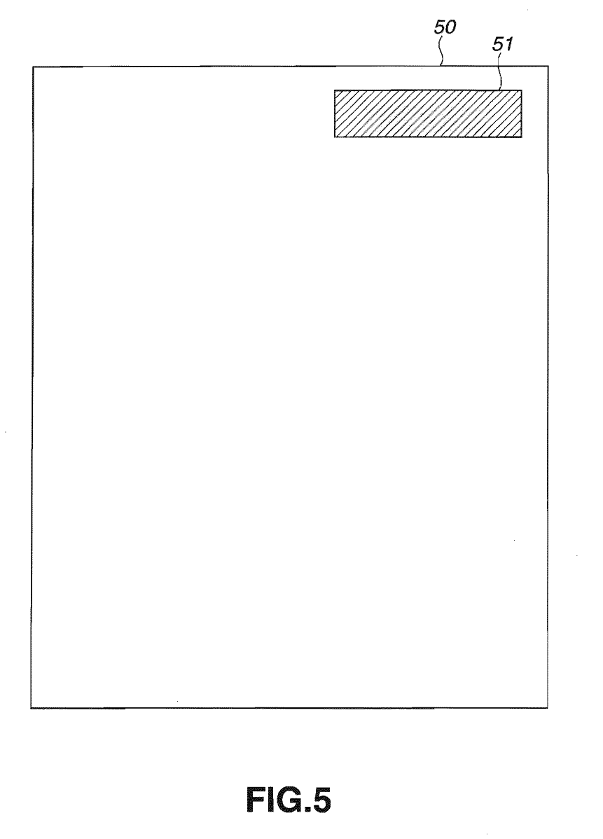

Additionally, the page ID is attached to each of the pages in the electronic document. However, when the document is printed out, it is printed as a code 51 as shown in a page 50 in FIG. 5. The code 51 may be formed by a character string or a machine-readable code. Additionally, it may also be possible to attach an IC tag and so on to a paper sheet on which the document is printed, and store the page ID in the IC tag.

The document input-output device 3 includes a document reading section 301, a document storing section 302, an identification information extract section 303, an excess/insufficiency determination section 304, an operation/display section 305, a document obtainment section 306, an editing processing section 307, an image formation section 308 and a document output section 309.

The document reading section 301 is a section that optically reads a document (original document) and generates an electronic document, and is realized by the image reading device 36, the calculation section 31 that operates the image reading device 36 and so on. The document storing section 302 is a section that stores the electronic document generated by the document reading section 301, and so on, and is realized by the storage device 35, the calculation section 3 1 that controls the input/output to the storage device 35 and so on. The identification information extract section 303 is a section that extracts the page ID from the electronic document stored in the document storing section 302, and is realized by the calculation section 31 and so on. The excess/insufficiency determination section 304 is a section that obtains document information from the document information management section 201 based on the page ID extracted by the identification information extract section 303 and determines the excess or insufficiency of the page of the electronic document read and generated by the document reading section 301, and is realized by the calculation section 31, the communication device 34 and so on. The operation/display section 305 is a section that provides information on a caution, etc. to the operator of the document input-output device 3 and receives an input of instruction from the operator, and is realized by the display/input device 38, the calculation section 31 that operates the device 38 and so on. The document obtainment section 306 is a section that obtains the insufficient page from the document accumulation section 202, and is realized by the calculation section 31, the communication device 34 and so on. The editing processing section 307 is a section that deletes overlapped page from the electronic document, incorporates the page obtained by the document obtainment section 306 to the electronic document and controls to incorporate added information to the electronic document accumulated in the document management device, and is realized by the calculation section 31 and so on. The image formation section 308 is a section that forms an image on a paper sheet or other medium based on the electronic document, and is realized by the image formation device 37, the calculation section 31 that operates the device 37 and so on. The document output section 309 is a section that outputs the electronic document to a client (not shown) connected to the network 4 and so on, and is realized by the calculation section 31, the communication device 34 and so on.

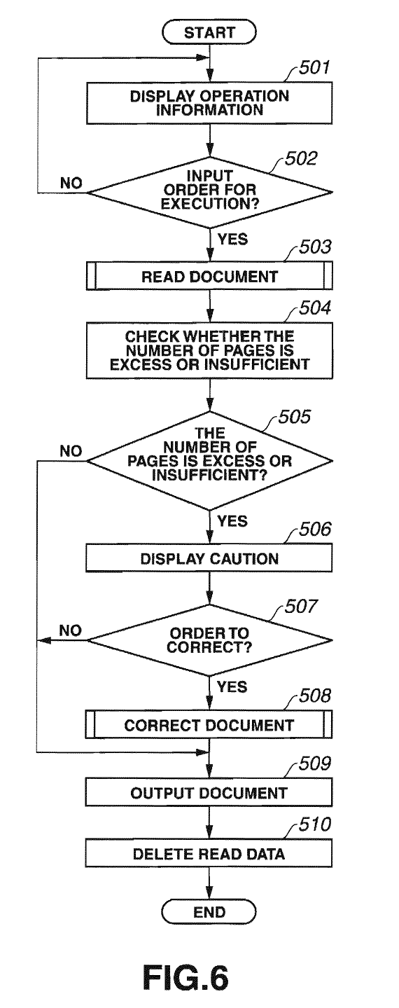

Next, operation of the document input-output device 3 will be described. FIGS. 6-8 are flowcharts illustrating operational flows of the document input-output device 3.

Upon starting its operation, the document input-output device 3 displays to the operation/display section 305 operation information to a user (step 501), and waits for user's operation (NO in step 502). Then, once the user makes an execution order operation (YES in step 502), the document input-output device 3 performs the document reading processing (step 503).

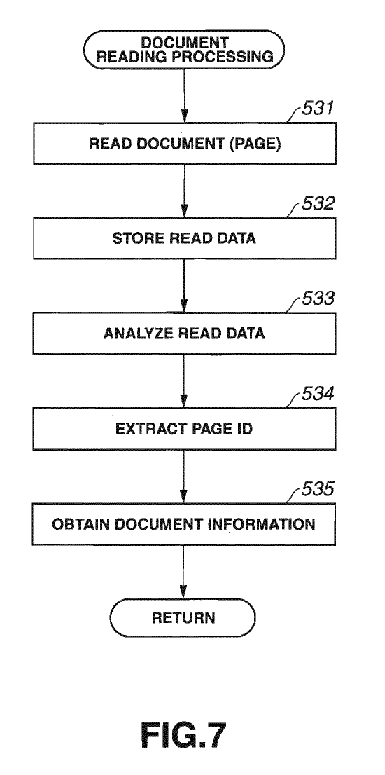

During the document reading processing, the document reading section 301 optically reads the page (step 531 in FIG. 7), and the thus obtained read data (electronic document) is stored in the document storing section 302 (step 532). Then, the identification information extract section 303 analyzes the read data stored in the document storing section 302 (step 533), and extracts the page ID based on the analysis result (step 534). After the identification information extract section 303 extracts the page ID, the excess/insufficiency determination section 304 obtains document information (see FIG. 4A) including a logical page number corresponding to the page ID from the document information management section 201 based on the page ID (step 535). It should be noted that each step of the document reading processing is performed in parallel. After the page reading processing for the first page in step 531 is completed, the read data storing processing for the first page in step 532 is performed while the page reading processing for the next page (having no hearing on the first page) in step 531 is started. Then, upon completing each of the processing from step 531 to step 535 for all the pages, the document reading processing ends.

After the document reading processing ends, the excess/insufficiency determination section 304 checks whether the number of pages of the read document is excess or insufficient on the basis of the document information obtained in step 535 (step 504 in FIG. 6). If plural types of documents exist, in other words, if there exist documents having different document IDs as shown in FIG. 4A, the determination of excess/insufficiency of page is made for each of the documents. Additionally, it is also checked whether a blank paper sheet or a page having no page ID is included or not.

If excess/insufficiency of page is found as a result of the check (YES in step 505), the operation/display section provides the user with a caution, through a display and so on, indicating that excess/insufficiency of page exists (step 506). Then, once the user performs an operation to give an order to make a correction in response to the caution (YES in step 507), the document input-output device 3 performs a document correction processing (step 508).

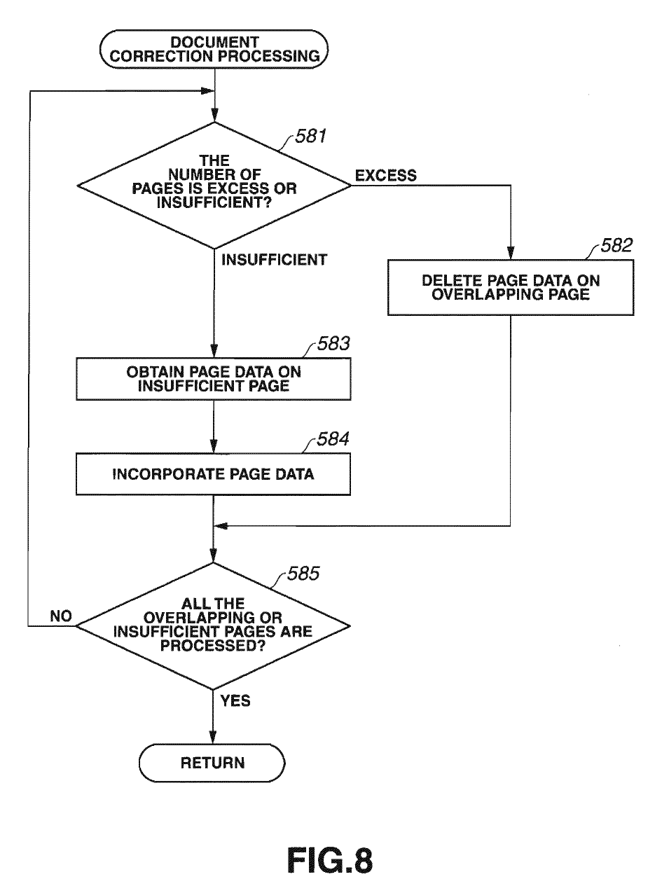

During the document correction processing, if the overlapped page exists (Excess in step 581 in FIG. 8), the editing processing section 307 deletes all the overlapped pages except for any one of the overlapped pages (step 582). Additionally, if there exists an insufficient page (Insufficient in step 581), the document obtainment section 306 obtains an electronic document of a page (page data) corresponding to the insufficient page from the document accumulation section 202 (step 583), and the editing processing section 307 incorporates the page data (step 584). Then, the series of processing above is repeated until all the excess/insufficiency are overcome (NO in step 585). After all the excess/insufficiency are overcome (YES in step 585), the document correction processing ends. It should be noted that the blank paper sheet or the page having no page ID is deleted if the user does not give any particular order.

In a case where the document correction processing ends, a case where the user does not perform any operation to give an order to make a correction (NO in step 507 in FIG. 6) or a case where no excess/insufficiency of page exist (NO in step 505), a document output processing is performed through either a document outputting using a medium by the image formation section 308 or a document outputting using an electronic document by the document outputting section 309 (step 509). Then, after the document is outputted, tile read data (including the page data obtained from the document accumulation section 502 at the time of insufficiency) stored in the document storing section 302 are deleted (step 510), and the processing ends. It should be noted that, when the document is outputted in step 509, pages are sorted in order of page. If plural types of documents are included, pages are sorted for each document.

### Second Example

In the second example, a case where the document correction processing is different from that described in the first example (FIG. 8) will be described. Since the configuration of the document input-output device 3 and so on is similar to that in the first example, explanation thereof is omitted.

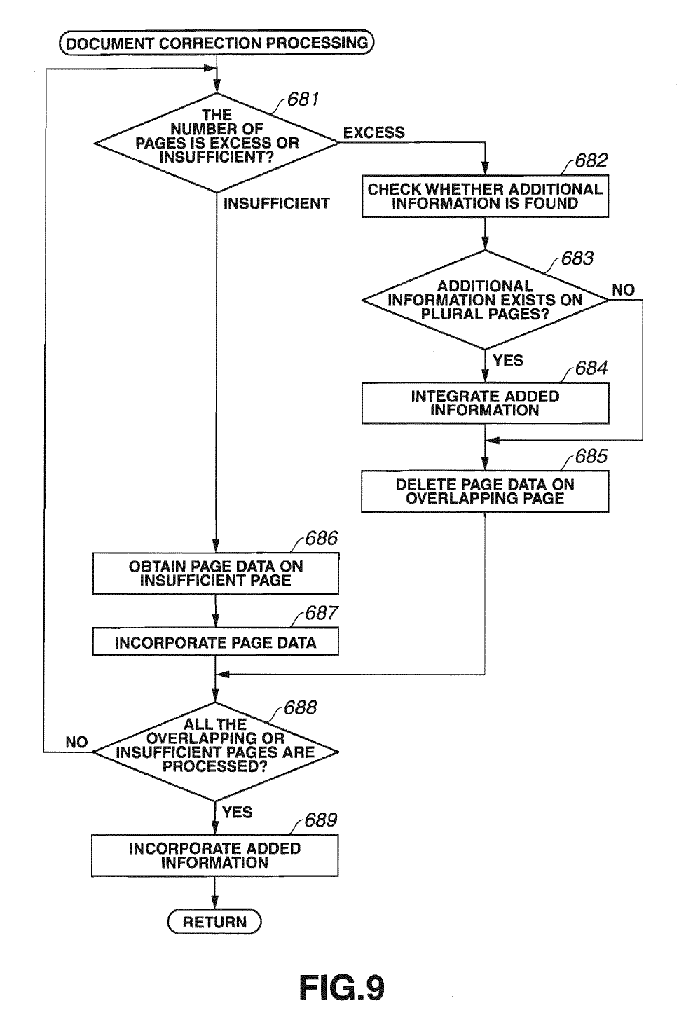

FIG. 9 is a flowchart illustrating a flow of a document correction processing in Second Example.

During the document correction processing, if the overlapped (excess) page exists (Excess in step 681), the editing processing section 307 checks whether or not there exists a handwritten memo, a signature, a stamp or other additional information on each of the overlapped pages (page having the same page number) (step 682). Then, if there exists additional information on plural pages (step 683), portions of such additional information are integrated into anyone of the overlapped pages (step 684). Such integration is performed by cutting off images (bitmap, etc.) of the added portions and integrating the images into other pages in which the images are not cut off. Then, of the overlapped pages, pages other than the page into which the integration is made are deleted when the additional portions are integrated; pages other than the page having the additional portion are deleted when the additional information exists on only one page; and pages other than any one of the overlapped pages are deleted when no additional information exists (Step 685).

Additionally, if the insufficient page exists (Insufficient in step 681), the document obtainment section 306 obtains an electronic document of a page (page data) corresponding to the insufficient page from the document accumulation section 202 (step 686), and the editing processing section 307 incorporates the page data (step 687). Then, tile series of processing above is repeated until all the excess/insufficiency are eliminated (NO in step 688). After all the excess/insufficiency are eliminated (YES in step 688), the editing processing section 307 controls to incorporate the added portion into the electronic document accumulated in the document management device when the additional information exists in the overlapped page (step 689), and the document correction processing ends.

### Third Example

In the third example, an example case where each of the functions of the document processing system I as described in the first and the second examples is realized in the document input-output device will be described.

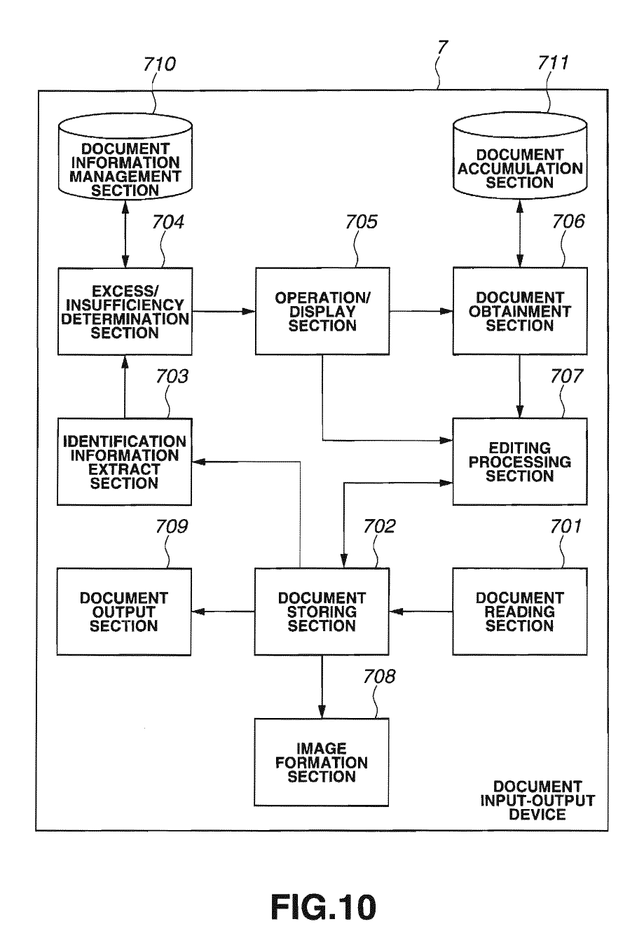

FIG. 10 is a block diagram illustrating a functional configuration of a document input-output device 7 in the third example. It should be noted that, since a configuration of the document input-output device 7 is similar to that of the document input-output device 3 as shown in FIG. 2, explanation thereof is omitted.

The document input-output device 7 includes a document reading section 701, a document storing section 702, an identification information extract section 703, an excess/insufficiency determination section 704, an operation/display section 705, a document obtainment section 706, an editing processing section 707, an image formation section 708, a document output section 709, a document information management section 710 and a document accumulation section 711.

The document reading section 701 is a section that generates an electronic document by optically reading the document (original document), and is realized by the image reading device 36, the calculation section 31 that operates the image reading device 36 and so on. The document storing section 702 is a section that stores the electronic document generated by the document reading section 701 and so on, and is realized by the storage device 35, the calculation section 31 that controls the input/output of the storage device 35, and so on. The identification information extract section 703 is a section that extracts a page ID from the electronic document stored in the document storing section 702, and is realized by the calculation section 31 and so on. The excess/insufficiency determination section 704 is a section that obtains document information from the document information management section 710 based on the page ID extracted by the identification information extract section 703 and determines whether the number of pages of the electronic document read and generated by the document reading section 701, and is realized by the calculation section and so on. The operation/display section 705 is a section that provides an operator of the document input-output device 7 with a caution or other information and receives an order input from the operator, and is realized by the display/input device 38, the calculation section 31 that operates the device 38 and so on. The document obtainment section 706 is a section that obtains an insufficient page from the document accumulation section 711, and is realized by the calculation section 31 and so on. The editing processing section 707 is a section that deletes an overlapped page from the electronic document, incorporates the page obtained by the document obtainment section 706 into the electronic document and incorporates the added portion to the accumulated electronic document, and is realized by the calculation section and so on. The image formation section 708 is a section that forms an image on a paper sheet or other medium based on the electronic document, and is realized by the image formation device 37, the calculation section 31 that operates the device 37, and so on. The document output section 709 is a section that outputs the electronic document to a client (not shown) connected to the network 4, and so on, and is realized by the calculation section 31, the communication device 34 and so on. The document information management section 710 is a section that manages information on a document accumulated in the document accumulation section 711, and is realized by the storage device 35, the calculation section 31 that controls input/output of the storage device 35, and so on. The document accumulation section 711 is a section that accumulates the electronic document in a state where the electronic document can be outputted on a per-page basis, and is realized by the storage device 35, the calculation section 31 that controls input/output of the storage device 35, and so on.

It should be noted that the document reading section 701, the document storing section 702, the identification information extract section 703, the excess/insufficiency determination section 704, the operation/display section 705, the document obtainment section 706, the editing processing section 707, the image formation section 708, the document output section 709, the document information management section 710 and the document accumulation section 711 operate similarly to the document reading section 301, the document storing section 302, the identification information extract section 303, the excess/insufficiency determination section 304, the operate/display section 305, the document obtainment section 306, the editing processing section 307, the image formation section 308, the document output section 309, the document information management section 201 and the document accumulation section 202, respectively. Thus, explanation for these sections is omitted.

Additionally, a program for operating the document management device 2 and a program for operating the document input-output device 3 may be provided, for example, through storing various memories, optical disc and other storing media, and may be distributed through the network or other communication lines.

The foregoing description of the exemplary embodiments of the present invention is provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing system, comprising:
a document management device having:
a management section that manages document information including association between a document in which identification information is attached to each page and the identification information; and
an accumulation section that accumulates an electronic document corresponding to the document, and
a document input-output device having:
a generation section that generates the electronic document through reading the document;
an extraction section that extracts the identification information from the electronic document generated by the generation section;
a determination section that obtains the document information managed by the management section based on the identification information extracted by the extraction section and determines whether pages are overlapped in the electronic document generated by the generation section based on the obtained document information;
a detection section that detects from the overlapped pages a presence or absence of an added portion in each of the overlapped pages when the determination section determines the presence of the overlapped pages;
a deletion section that deletes a page not having the added portion among the overlapped pages;
a controller that controls to incorporate the page having the added portion among the overlapped pages to a corresponding page in the electronic document accumulated in the document management device; and
an output section that outputs the electronic document including the incorporated page, or outputs the electronic document as a document through image formation on a medium.

2. The document processing system according to claim 1, wherein the document input-output device further comprises:
an integration section that integrates the detected added portion into any one of the overlapped pages when the detection section detects the added portion,
the deletion section of the document input-output device deleting a page other than the page into which the added portion is integrated by the integration section, and
the controller of the document input-output device controlling to incorporate the page into which the added portion is integrated to a corresponding page in the electronic document accumulated in the document management device.

3. A document input-output device, comprising:
a management section that manages document information including association between a document in which identification information is attached to each page and the identification information;
an accumulation section that accumulates an electronic document corresponding to the document;
a generation section that generates the electronic document through reading the document in which the identification information is attached to each of the page;
an extraction section that extracts the identification information from the electronic document generated by the generation section;
a determination section that obtains the document information from the management section that manages the document information including the association between the identification information and the document based on the identification information extracted by the extraction section, and determines whether pages are overlapped in the electronic document generated by the generation section based on the obtained document information;
a detection section that detects from the overlapped pages a presence or absence of an added portion in each of the overlapped pages when the determination section determines the presence of the overlapped pages;
a deletion section that deletes a page not having the added portion among the overlapped images;
a controller that controls to incorporate the page having the added portion among the overlapped images to a corresponding page in the accumulated electronic document; and
an output section that outputs the electronic document including the incorporated page, or outputs the electronic document as a document through image formation on a medium.

4. The document input-output device according to claim 3, further comprising:
an integration section that integrates the detected added portion into any one of the overlapped pages when the detection section detects the added portion;
wherein
the deletion section deletes a page other than the page into which the added portion is integrated by the integration section, and
the controller controls to incorporate the page into which the added portion is integrated to a corresponding page in the accumulated electronic document.

5. A computer readable recording medium storing a document input-output program that causes the computer to execute a process, the process comprising:
managing document information including association between a document in which identification information is attached to each page and the identification information;
accumulating an electronic document corresponding to the document;
generating the electronic document through reading the document in which the identification information is attached to each of the page;
extracting the identification information from the generated electronic document;
obtaining document information from the managed document information including the association between the identification information and the document based on the extracted identification information;
determining whether pages are overlapped in the generated electronic document based on the obtained document information;
detecting from the overlapped pages a presence or absence of an added portion in each of the overlapped pages when the presence of the overlapped pages is determined;
deleting a page not having the added portion from the overlapped pages;
controlling to incorporate the page having the added portion among the overlapped pages to a corresponding page in the accumulated electronic document; and
performing outputting of the electronic document including the incorporated page or outputting of the electronic document as a document through image formation on a medium.

6. A computer readable recording medium storing a document input-output program that causes the computer to execute a process, the process comprising:
managing document information including association between a document in which identification information is attached to each page and the identification information;
accumulating an electronic document corresponding to the document;
generating the electronic document through reading the document;
extracting the identification information from the generated electronic document;
obtaining document information from the managed document information including the association between the identification information and the document based on the extracted identification information;
determining whether pages are overlapped in the generated electronic document based on the obtained document information;
detecting from the overlapped pages a presence or absence of an added portion in each of the overlapped pages when the presence of the overlapped pages is determined;
integrating the detected added portion into any one of the overlapped pages when the added portion is detected;
deleting a page other than the page into which the added portion is integrated;
controlling to incorporate the page into which the added portion is integrated to a corresponding page of the accumulated electronic document; and
performing outputting of the electronic document including the incorporated page or outputting of the electronic document as a document through image formation on a medium.

7. A document processing method, comprising:
managing document information including association between a document in which identification information is attached to each page and the identification information;
accumulating an electronic document corresponding to the document;
generating the electronic document through reading the document;
extracting the identification information from the generated electronic document;
obtaining the managed document information based on the extracted identification information;
determining whether pages are overlapped in the generated electronic document based on the obtained document information;
detecting from the overlapped pages a presence or absence of an added portion in each of the overlapped pages when the presence of the overlapped pages is determined;
deleting a page not having the added portion from the overlapped pages;
controlling to incorporate the page having the added portion among the overlapped pages to a corresponding page in the accumulated electronic document; and
performing outputting of the electronic document including the incorporated page or outputting of the electronic document as a document image formation on a medium through.
